(19) United States
(12) Patent Application Publication
(10) Pub. No.: US 2022/0315238 A1
(43) Pub. Date: Oct. 6, 2022

(54) COOLING AN ELECTRICAL ENERGY DISTRIBUTION NETWORK

(71) Applicant: Airbus SAS, Blagnac (FR)

(72) Inventor: Thomas FULCHER, Bristol (GB)

(21) Appl. No.: 17/708,723

(22) Filed: Mar. 30, 2022

(30) Foreign Application Priority Data
Mar. 31, 2021 (GB) 2104585.1

(51) Int. Cl. B64D 33/08; B60L 58/26; B60L 58/33; B60K 1/04

(52) U.S. Cl. CPC B64D 33/08; B60L 58/26; B60L 58/33; B60K 1/04; B60L 2200/10; B60K 2001/006

(57) ABSTRACT

A vehicle, including a high voltage energy consumer; an electrical energy source; an electrical energy distribution network having an electrical energy distribution element configured to carry electrical power from the electrical energy source to the high voltage energy consumer; and a cooling system for cooling the high voltage energy consumer, the cooling system having: coolant, and a coolant distribution network having a coolant distribution element for delivering the coolant to the high voltage energy consumer to remove heat generated by the high voltage energy consumer; wherein the coolant distribution element provides mechanical support to the electrical energy distribution element, and the coolant within in the coolant distribution element removes heat generated in the electrical energy distribution element as it carries electrical power from the electrical energy source to the high voltage energy consumer

### RELATED APPLICATION

This application incorporates by reference and claims priority to United Kingdom Patent Application GB 2104585.1, filed Mar. 31, 2021.

### TECHNICAL FIELD

The present invention relates to cooling an electrical energy distribution network, in particular it relates to cooling an electrical energy distribution network in a vehicle.

### BACKGROUND

Electric and electric-hybrid propulsion in vehicles, including aircraft, is an important area of development, and provides many benefits. However, replacing more traditional forms of propulsion, such as gas-turbine jet engines and jet-fueled turboprop engines, with alternative electric propulsion alternatives gives rise to many challenges and difficulties that must be overcome.

Electric propulsion, for example a ducted fan in an aircraft driven by an electric motor, requires a high voltage power supply. Distribution of high voltage power around the aircraft to the high voltage equipment, such as the electric propulsion system, gives rise to a number of challenges in itself. Due to weight and free space constraints in vehicles, the power supply cables must be of a relatively small diameter. However, having smaller diameter cables in turn creates high temperatures due to the high energy passing through the thinner diameter cables.

In addition, high voltage equipment, such as an electric propulsion motor generates large amounts of heat and requires cooling. Typically each motor has its own cooling system, and it is generally understood that significant effort should be taken to ensure the cooling system is kept separated from the high voltage power supply to avoid any risk of the coolant interfering with the power supply, and potentially causing damage to the high voltage equipment and the power supply interface. A simple and effective way to do this is to keep the high voltage power supply physically separated from the cooling system. However, this negatively impacts the size of the installation of the cooling system and electric components within the vehicle.

Improvements in thermal management are therefore required in order that the full benefits of electric and electric-hybrid propulsion in vehicles, in particular aircraft, can be realised.

### SUMMARY

An aspect of the present invention provides a vehicle, comprising: a high voltage energy consumer; an electrical energy source; an electrical energy distribution network comprising an electrical energy distribution element configured to carry electrical power from the electrical energy source to the high voltage energy consumer; and a cooling system for cooling the high voltage energy consumer, the cooling system comprising: coolant, and a coolant distribution network comprising a coolant distribution element for delivering the coolant to the high voltage energy consumer to remove heat generated by the high voltage energy consumer; wherein the coolant distribution element provides mechanical support to the electrical energy distribution element, and the coolant within in the coolant distribution element removes heat generated in the electrical energy distribution element as it carries electrical power from the electrical energy source to the high voltage energy consumer.

As a result, the cooling system that cools the high voltage energy consumer has multiple responsibilities: also being used to cool the electrical energy distribution network, as well as acting to mechanically support the electrical energy distribution element. This removes the need to have separate systems for providing each of these operations. In addition, it may allow the electrical energy distribution element 5 to be made smaller and lighter. In turn these effects can maximise the efficient use of space within the vehicle, and can help minimise the size and weight of the overall vehicle.

The coolant distribution element may be a coolant pipe through which the coolant can flow. Thus coolant can flow through the cooling system carrying heat away from areas where significant heat is being generated.

The coolant pipe may be formed of a non-metallic material. The coolant pipe may be formed of a thermally conductive composite material. As a result, the coolant pipe can be positioned as close to the electrical energy distribution element as possible, thus improving the cooling efficiency, but while also minimising any risk of an undesirable electrical event such as a short circuit.

The electrical energy distribution network may comprise a plurality of electrical energy distribution elements, and each of the plurality of electrical energy distribution elements may be mechanically supported by the coolant distribution element, and heat generated in each of the plurality of the electrical energy distribution elements may be removed by the coolant in the coolant distribution element. As a result, further space and weight savings can be achieved.

The plurality of electrical energy distribution elements and the coolant distribution element may be provided together in a bundle. This can improve convenience when it is required to manoeuvre the electrical energy distribution elements and the coolant distribution element together, for instance during assembly or maintenance of the vehicle.

The coolant distribution element may be positioned in a centre of the bundle, and the plurality of electrical energy distribution elements may be positioned around the coolant distribution element. As a result, each of the plurality of electrical energy distribution elements experience an equal share of the cooling effect from the coolant distribution element in the centre of the bundle.

The electrical energy distribution network may be configured such that each of two or more electrical energy distribution elements carries alternating current of a respective different phase from a multiphase electrical energy source to a multiphase high voltage electrical energy consumer, and each of the two or more electrical energy distribution elements may be supported by the coolant distribution element. This can provide a convenient and efficient solution in a multiphase power environment.

The high voltage energy consumer may be a vehicle electrical propulsion motor.

The electrical energy source may comprise one or a combination of: a battery, a generator, a fuel cell, and a photovoltaic cell.

The coolant may be used as a fuel for a vehicle component. Thus this can remove the need to have both a coolant and a fuel. This can further reduce weight that is required to be carried by the vehicle, and may improve fuel efficiency and or total range for the vehicle.

The vehicle component may be a fuel cell, and the coolant may be liquid hydrogen.

The vehicle may be an aircraft.

### BRIEF DESCRIPTION OF THE DRAWINGS

Embodiments of the invention will now be described, by way of example only, with reference to the accompanying drawings, in which:

FIG. 1 shows a schematic view of a vehicle;

FIG. 2 shows a cross-sectional view though an electrical energy distribution element being supported by a coolant distribution element;

FIG. 3 shows a cross-sectional view through a bundle comprising multiple electrical energy distribution elements being supported by a coolant distribution element;

FIG. 4 shows a schematic view of a vehicle;

FIG. 5 shows an aircraft;

FIG. 6 shows a magnified view of a portion of the aircraft of FIG. 5; and

FIG. 7 is a cross-sectional view through the leading edge of an aircraft wing.

### DETAILED DESCRIPTION

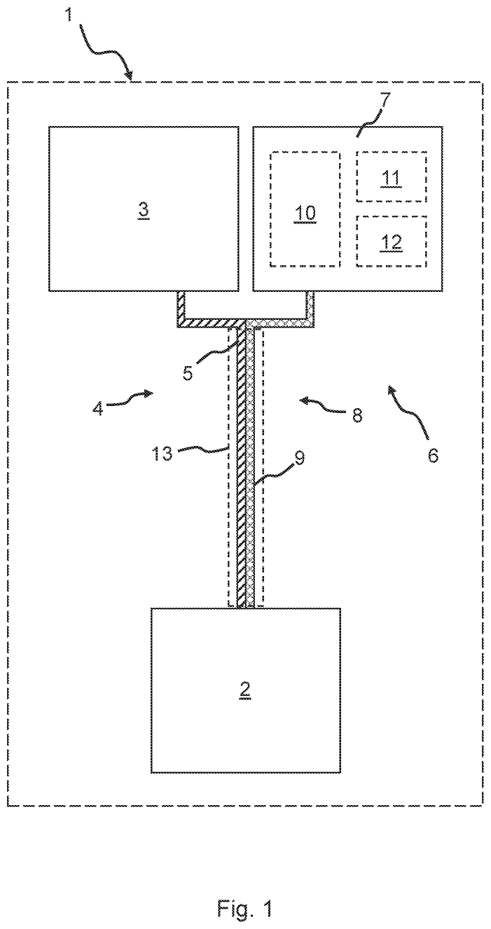

FIG. 1 shows a schematic view of a vehicle 1. The vehicle 1 comprises a high voltage electrical energy consumer 2, an electrical energy source 3, and an electrical energy distribution network 4. The electrical energy distribution network 4 comprises an electrical energy distribution element 5 which carries electrical power from the electrical energy source 3 to the high voltage electrical energy consumer 2. The high voltage electrical energy consumer 2 may be, for example, an electrical motor used for propulsion of the vehicle 1, or any other electrical energy consumer that consumes high voltage electrical energy from the electrical energy distribution network 4. The electrical energy source 3 may be one or a combination of, for example, a battery, generator, fuel cell (e.g. producing electrical energy from a chemical reaction), photovoltaic cell, or any other electrical energy source that provides electrical energy to the electrical energy distribution network 4. The electrical energy distribution element 5 may be, for example, an electrical energy distribution cable or bus-bar or any other element that distributes electrical energy, for example by transporting electrons. The electrical energy distribution element 5 may be made from a single material such as aluminium or copper and/or a combination of different materials such as copper and aluminium, for example including a COPALUM connection. The electrical energy distribution network 4 may comprise more than one electrical energy distribution element required to carry electrical power from the electrical energy source 3 to the high voltage electrical energy consumer 2.

Although in the examples described hereinafter, the specific example of electrical energy distribution cables is referred to, it will be appreciated that any other electrical energy distribution elements 5 that distribute electrical energy, for example by transporting electrons, may be used. Moreover, hereinafter, for the sake of brevity, the electrical energy distribution network 4 may be referred to simply as a ‘network’, an electrical energy source 3 may be referred to as a ‘source’, a high voltage electrical energy consumer 2 may be referred to as a ‘consumer’, and electrical energy distribution cables may be referred to simply as ‘cables’.

The vehicle 1 further comprises a cooling system 6. The cooling system 6 has a primary purpose to cool the consumer 2. The cooling system 6 comprises coolant which is delivered to the consumer 2 through a coolant distribution element 9 in a coolant distribution network 8. Heat generated by the consumer 2 is transferred to the coolant which then carries the heat away from the consumer 2. In the example shown in FIG. 1, coolant system 6 comprises coolant system apparatus 7. The coolant system apparatus 7 is a schematic representation of the typical components of a cooling system, for example the coolant system apparatus 7 in FIG. 1 comprises a coolant reservoir 10, a compressor 11 and a condenser 12. It will be understood that the components shown in coolant system apparatus 7 are only provided by way of example, and are also shown grouped together purely for the sake of simplicity and may not be physically located together. The coolant distribution network 8 also has a return pathway (not shown) for the coolant to return to the coolant system apparatus 7 once it has cooled the consumer 2. This return pathway may take the form of a further coolant distribution element (not shown). This further coolant distribution element may follow the same route as coolant distribution element 9 but in reverse, or it may be kept separate from coolant distribution element 9.

Along a distance indicated by the dotted line box 13 the coolant distribution element 9 and the electrical energy distribution element 5 are positioned together. As discussed above in the background section, it is typically understood that a cooling system should be kept very separate from electric components. However, in the present example, the coolant distribution element 9 provides mechanical support to the electrical energy distribution element 5, acting as a cable support, or bobbin. Furthermore, the proximity of the coolant distribution element 9 with the electrical energy distribution element 5 allows for heat transfer between the two. As such, as electrical energy passes through the electrical energy distribution element 5 heat is generated, but this heat is able to pass to the coolant distribution element 9, and then is carried away by the coolant flowing through it. Therefore the coolant system 6 has a further beneficial purpose to cool the electrical energy distribution element 5 in the electrical energy distribution network 4. Having improved cooling, and mechanical support from the coolant distribution element 9 may allow the electrical energy distribution element 5 to be made smaller and lighter, which in turn can help reduce the overall weight and size of the vehicle.

The coolant distribution element 9 may be, for example, a coolant pipe through which a liquid and/or gaseous coolant may flow. The coolant distribution element 9 may be made from a non-metallic material. Due to the proximity of the coolant distribution element 9 with the electrical component the electrical energy distribution element 5, it is preferable that it is formed of an electrically insulating material to reduce any risk of it interfering with the power supply, for example causing arcing or a short circuit. It is particularly preferable for the coolant distribution element 9 to be formed of an electrically insulating composite material having high mechanical strength, and high thermal conductivity. One example of a particularly beneficial material would be Kevlar®.

The coolant used in the cooling system can be selected as appropriate from known coolants or refrigerants. For example, it may be a hydrofluorocarbon (HFC) such as 1,1,1,2-tetrafluoroethane (also known as R-134a). Alternatively, the coolant may be a two-phase cooling refrigerant.

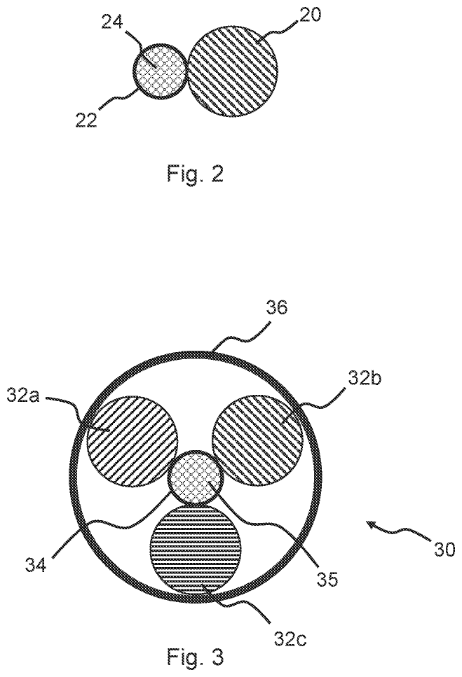

FIG. 2 shows a cross sectional view though an electrical energy distribution element in the form of a cable 20 and coolant distribution element in the form of coolant pipe 22. Cable 20 is supported mechanically by the coolant pipe 22. Coolant 24 (represented by a hatched area) flows through the coolant pipe 22. One or more fasteners or temporary fasteners (not shown) may be used to keep the cable 20 and the coolant pipe 22 held together. In addition, or alternatively, the cable may be helically wound around the cooling pipe 22.

In a first example, an electrical energy distribution network may be configured such that a given current carried by the network between the source and consumer is shared across, for example shared equally across, a number of cables. For example, the cables may be connected in parallel with one another so as to share the given current between them.

In a second example, an electrical energy distribution network may be configured such that a first cable carries alternating current of a first phase between a multiphase source and a multiphase consumer, and a second cable carries alternating current of a second, different, phase between the multiphase source and the multiphase consumer. For example, the first cable may be connected to a first phase terminal of the multiphase source and the second cable may be connected to a second phase terminal of the multiphase source.

In these examples, it may be beneficial that all, or a plurality, of the cables are supported by the same coolant pipe, and the cables together with the coolant pipe are provided together as a bundle. The coolant pipe will remove the heat from each of the cables in the bundle.

Referring to FIG. 3, there is a cross sectional view through a bundle 30 comprising multiple electrical energy distribution elements supported by a coolant distribution element. In particular, the bundle 30 comprises three current carrying cables 32a, 32b, 32c. Cable 32a carries alternating current of a first phase to a first phase terminal of a multiphase consumer, cable 32b carries alternating current of a second phase to a second phase terminal of the multiphase consumer, and cable 32c carries alternating current of a third phase to a third phase terminal of the multiphase consumer. For example, each of the first, second, and third phase of alternating current differ by 120 degrees. Each of the cables 32a, 32b, 32c are positioned around coolant pipe 34. The coolant pipe 34 supports the cables 32a, 32b, 32c, and heat from them transfers through the coolant pipe 34 into coolant 35 which flows through the coolant pipe 34. As such each of the cables 32a, 32b, 32c is effectively cooled by coolant pipe 34. In this example, a sleeve 36 is provided around the outside of the bundle to help keep the cables 32a, 32b, 32c and the coolant pipe 34 together. The cables may further be helically wound around the coolant pipe 34.

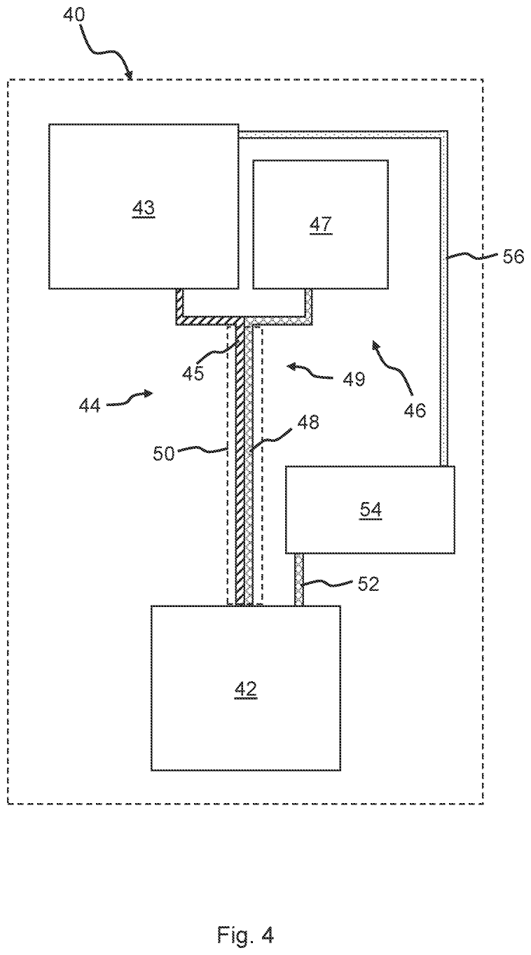

FIG. 4 shows a schematic view of a vehicle 40. Similar to the vehicle 1 of FIG. 1, the vehicle 40 comprises a high voltage electrical energy consumer 42, an electrical energy source 43, and an electrical energy distribution network 44. For simplicity, the electrical energy distribution network 44 is shown comprising a single electrical energy distribution element 45 which carries electrical power from the electrical energy source 43 to the high voltage electrical energy consumer 42, however it will be understood in light of what has been described above that the electrical energy distribution network 44 may comprise multiple electrical energy distribution elements. The high voltage electrical energy consumer 42 may be, for example, an electrical motor used for propulsion of the vehicle 40, or any other electrical energy consumer that consumes high voltage electrical energy from the electrical energy distribution network 44. The electrical energy source 43 may be a battery, or any other electrical energy storage solution. As with the example described in FIG. 1, the electrical energy distribution element 5 may be, for example, an electrical energy distribution cable or busbar or any other element that distributes electrical energy.

The vehicle 40 further comprises a cooling system 46. The cooling system 46 comprises a coolant storage tank 47 containing coolant which is delivered to the consumer 42 through a coolant distribution element 48 in a coolant distribution network 49. Heat generated by the consumer 42 is transferred to the coolant which then then transports the heat away from the consumer 42.

Along a distance indicated by the dotted line box 50 the coolant distribution element 48 and the electrical energy distribution element 45 are positioned together. The coolant distribution element 48 provides mechanical support to the electrical energy distribution element 45, and acts as a cable support, or bobbin. The proximity of the coolant distribution element 48 with the electrical energy distribution element 45 allows for heat transfer between the two. As such, as electrical energy passes through the electrical energy distribution element 45 heat is generated, but this heat is able to pass to the coolant distribution element 48, and then is removed by the coolant flowing through it.

In this example, the coolant used in the cooling system is liquid hydrogen. Although not a typical coolant, the use of liquid hydrogen in this example is particularly beneficial as it can additionally act as a fuel. After the liquid hydrogen has been used to cool both the electrical energy distribution element 45 and the consumer 42 it passes through a pipe 52 to a hydrogen fuel cell 54. The fuel cell 54 uses the hydrogen as a fuel to generate electricity. The electricity generated by fuel cell 54 flows through cable 56 back to the electrical energy source 43 where it is stored and can be used to power the high voltage electrical energy consumer 42. Alternatively, the generated power may be used to power auxiliary and/or ancillary systems of the vehicle.

In a further alternative example, the hydrogen may be used as a fuel for a different vehicle component that is not a fuel cell. For example, the hydrogen may be used as a clean fuel for a propulsion engine, such as an internal combustion or jet engine.

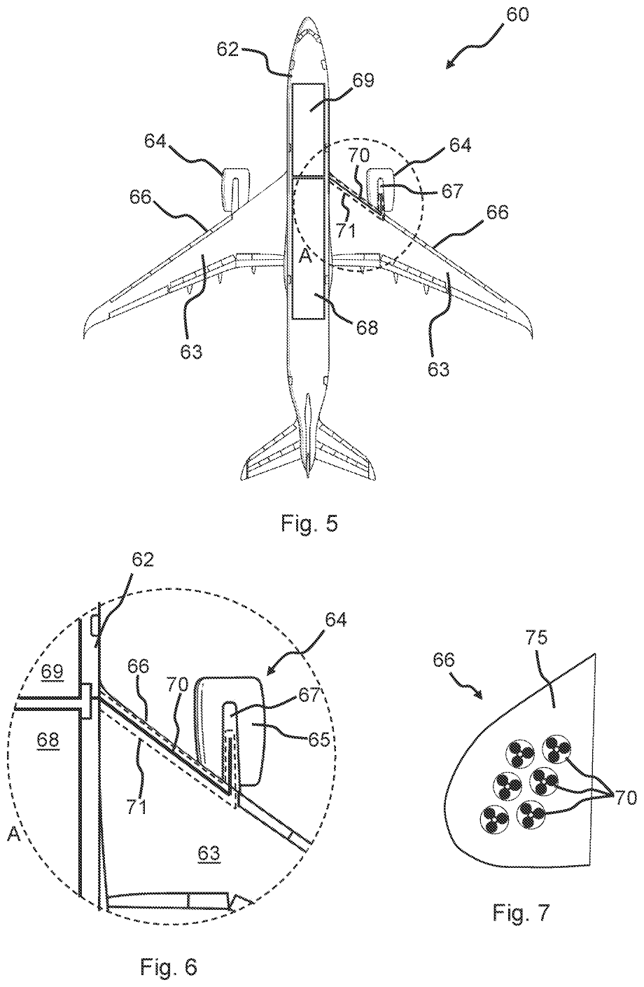

Referring to FIG. 5, there is illustrated a vehicle 60 to which the schematic representation of any one of the examples described herein may be applied. In this example, the vehicle is an aircraft 60, specifically a passenger aircraft 60. Similarly to the schematic representation examples of FIGS. 1 and 4, an electrical energy distribution network may distribute electrical energy from an electrical energy source to a high voltage energy consumer embodied as a propulsion system of the aircraft 60. The aircraft 60 has a fuselage 62 and wings 63. FIG. 6 shows an enlarged view of part of the aircraft 60 of FIG. 1, indicated by the dotted circle A. Attached to the wings 63 are propulsion engines 64. Each propulsion engine 64 comprises a ducted fan driven by an electric motor housed within a nacelle 65. The wings 63 each have a leading edge 66 at the front of the wing 63, and the propulsion engine 64 is attached to the wing 63 by way of a pylon 67.

Electric power is provided to drive the electric motors from an electrical energy source 68, which for example may be one or more of a combination of an energy storage solution such as batteries, hydrogen fuel cells, or a hybrid power generating system. The electrical energy source in the present example is located in the fuselage 62 of the aircraft 60. However, alternatively, the electrical energy source 68 could be located in other areas of the aircraft, or may be split into more than one energy source and distributed across a number of different areas of the aircraft 60.

The electrical power is delivered from the electrical energy source 68 to the electric motor in the propulsion engine 64 through an electrical distribution network comprising high voltage electrical cables.

The aircraft 60 further comprises a cooling system for cooling the propulsion engine 64. Coolant is delivered from a coolant reservoir 69 to the propulsion engine 64 by way of a coolant distribution network comprising coolant pipes. As described previously, high voltage cables are brought together around a coolant pipe to form a bundle 70. An example of one of the bundles 70 is shown schematically in FIGS. 5 and 6. The bundle 70 runs from the fuselage 62, through a cavity 70 on the inside of the leading edge 66 of the wing 63, and then passes through the pylon 67 into the nacelle 65 where it connects with the propulsion engine 64. Separate cooling systems for each propulsion engine may be provided, or alternatively a single cooling system may be used to cool all propulsion engines in the aircraft. If a single cooling system is used, it may comprise a number of separate cooling circuits, with each propulsion engine being served by its own cooling circuit.

A synergistic advantage is achieved, whereby the coolant pipe not only mechanically supports the high voltage cables and helps to keep the high voltage cables cool, but also, the high temperatures generated by the high voltage cables help to reduce condensation and ice build-up around the coolant pipe, and in and around the area of the leading edge of the wing 66.

FIG. 7 shows a cross sectional view through the leading edge 66 of the wing 63. Thea body of the leading edge 66 defines a cavity 75. A number of bundles 70, which are similar to that described in FIG. 3, run through the cavity 75.

The above examples are to be understood as illustrative examples of the invention. It is also to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims

For instance, the aircraft may comprise a mixture of propulsion types, with one or more being electric or hybrid propulsion engines, and one or more being more traditional gas turbine jet engines. In addition, although the embodiments described herein have described the propulsion engine as being an electric ducted fan driven by an electric motor, it will be understood that the propulsion engine may alternatively be a different type of electric or hybrid propulsion engine, such as a propeller driven by an electric motor.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A vehicle comprising:
a high voltage electrical energy consumer;
an electrical energy source;
an electrical energy distribution network including:
an electrical energy distribution element configured to carry electrical power from the electrical energy source to the high voltage energy consumer; and
a cooling system for cooling the high voltage energy consumer, the cooling system comprising:
coolant, and
a coolant distribution network comprising a coolant distribution element configured to deliver the coolant to the high voltage energy consumer to remove heat generated by the high voltage energy consumer;
wherein the coolant distribution element is configured to provide mechanical support to the electrical energy distribution element, and
wherein the coolant within in the coolant distribution element removes heat generated in the electrical energy distribution element as the coolant carries electrical power from the electrical energy source to the high voltage energy consumer.

2. The vehicle according to claim 1, wherein the coolant distribution element is a coolant pipe through which the coolant can flow.

3. The vehicle according to claim 2, wherein the coolant pipe is formed of a non-metallic material.

4. The vehicle according to claim 3, wherein the coolant pipe is formed of a thermally conductive composite material.

5. The vehicle according to claim 1, wherein the electrical energy distribution network comprises a plurality of electrical energy distribution elements, and each of the plurality of electrical energy distribution elements is mechanically supported by the coolant distribution element, and heat generated in each of the plurality of the electrical energy distribution elements is removed by the coolant in the coolant distribution element.

6. The vehicle according to claim 5, wherein the plurality of electrical energy distribution elements and the coolant distribution element are provided together in a bundle.

7. The vehicle according to claim 6, wherein the coolant distribution element is positioned in a centre of the bundle, and the plurality of electrical energy distribution elements are positioned around the coolant distribution element.

8. The vehicle according to claim 1, wherein the electrical energy distribution network is configured such that each of two or more electrical energy distribution elements carries alternating current of a respective different phase from a multiphase electrical energy source to a multiphase high voltage electrical energy consumer, and each of the two or more electrical energy distribution elements are supported by the coolant distribution element.

9. The vehicle according to claim 1, wherein the high voltage electrical energy consumer is a vehicle electrical propulsion motor.

10. The vehicle according to claim 1, wherein the electrical energy source comprises one or a combination of: a battery, a generator, a fuel cell, and a photovoltaic cell.

11. The vehicle according to claim 1, wherein the coolant is used as a fuel for a vehicle component.

12. The vehicle according to claim 11, wherein the vehicle component is a fuel cell.

13. The vehicle according to claim 11, wherein the coolant is liquid hydrogen.

14. The vehicle according to claim 1, wherein the vehicle is an aircraft.
